(19) United States
(12) Patent Application Publication
(10) Pub. No.: US 2025/0258347 A1
(43) Pub. Date: Aug. 14, 2025

(54) EYE-TRACKING VIA LIGHTGUIDES

(71) Applicant: LUMUS LTD., Ness Ziona (IL)

(72) Inventors: Yochay DANZIGER, Kfar Vradim (IL); Daniel MICHAELS, Ramat Gan (IL)

(21) Appl. No.: 18/859,204

(22) PCT Filed: Apr. 24, 2023
(86) PCT No.: PCT/IL2023/050420

§ 371 Date: Oct. 23, 2024

Related U.S. Application Data
(60) Provisional application No. 63/334,191, filed on Apr. 24, 2022.

(51) Int. Cl. G02B 6/42; G02B 27/01

(52) U.S. Cl. CPC G02B 6/4215; G02B 6/42; G02B 27/0179; G02B 2027/0187

(57) ABSTRACT

An apparatus for delivering an image to a human eye (30) and deriving a gaze direction includes an image-output lightguide (20), visible and non-visible illumination coupling-out arrangements (22V, 24V), a receiving lightguide (50), and a filter layer (56, 56a, 56b). The image-output lightguide guides light by internal reflection. The visible-image coupling-out arrangement couples out visible light corresponding to a visible image, while the non-visible-illumination coupling-out arrangement couples out non-visible illumination of at least one wavelength. The receiving lightguide (50) has a coupling-in configuration (52V) for non-visible illumination reflected from the eye. The filter layer (56, 56a, 56b) blocks non-visible light from passing to the eye except in the non-visible-light coupling-out area (57a, 57b), which is smaller than an image coupling-out area (53).

### FIELD AND BACKGROUND OF THE INVENTION

The present invention relates to near-eye displays and, in particular, it concerns a near-eye display which employs a lightguide arrangement both for image display and for eye tracking.

Many near-eye display systems include a transparent lightguide or “waveguide” placed before the eye of the user, which conveys an image within the lightguide by internal reflection and then couples out the image by a suitable output coupling mechanism towards the eye of the user. The output coupling mechanism may be based on embedded partially-reflecting surfaces or “facets,” or may employ a diffractive pattern. The description below will refer primarily to a facet-based coupling-out arrangement, but it should be appreciated that certain features of the invention are also applicable to diffractive arrangements.

Some lightguide-based displays employ a lightguide arrangement which achieves expansion of an optical aperture of an image projector in two dimensions in order to employ a miniature projector to provide a much larger viewing area to the eye. Two-dimensional expansion can be achieved by employing an additional set of embedded partially-reflecting surfaces within the same lightguide, for example, as disclosed in PCT Patent Application Publication No. WO 2020/049542 A1, or by employing a separate rectangular lightguide, for example, as disclosed in PCT Patent Application Publication No. WO 2018/065975 A1.

It is desirable for many applications to track eye movements while a user is viewing a near-eye display.

### SUMMARY OF THE INVENTION

The present invention is an apparatus for delivering an image to a human eye and for deriving a gaze direction of the human eye.

According to the teachings of an embodiment of the present invention there is provided, an apparatus for delivering an image to a human eye and for deriving a gaze direction of the human eye, the apparatus comprising: (a) an image-output lightguide formed from transparent material and having pair of parallel faces for guiding light by internal reflection, one of the parallel faces being deployed in facing relation to the eye; (b) a visible-image coupling-out arrangement associated with the image-output lightguide and configured for coupling out visible light propagating within the image-output lightguide corresponding to a visible image from an image-coupling-out area towards the eye for viewing by the eye; (c) a non-visible-illumination coupling-out arrangement associated with the image-output lightguide and configured for coupling out non-visible illumination of at least one wavelength propagating within the image-output lightguide from an illumination-coupling-out area, a majority of the image-coupling-out area being outside the illumination-coupling-out area; (d) a receiving lightguide formed from transparent material and having a pair of parallel faces for guiding light by internal reflection, the receiving lightguide being deployed parallel to the image-output lightguide and between the image-output lightguide and the eye; (e) a coupling-in configuration associated with the receiving lightguide and configured for coupling-in non-visible illumination reflected from the eye so as to propagate within the receiving lightguide; and (f) a filter layer extending parallel to the image-output and receiving lightguides, the filter layer blocking the non-visible light from passing from at least a majority of the image-coupling-out area of the image-output lightguide to the eye while allowing visible light from the image-output lightguide to reach the eye, the filter layer being omitted from the illumination-coupling-out area, such that, when a collimated visible image and non-visible illumination of the at least one wavelength are introduced into the image-output lightguide so as to propagate within the image-output lightguide, the visible image is coupled out by the visible-image coupling-out arrangement and passes through the receiving lightguide and the filter layer to be viewed by the eye, and the non-visible illumination is coupled-out by the non-visible-illumination coupling-out arrangement and passes via the receiving lightguide to the eye, is partially reflected by the eye, and is coupled in to the receiving lightguide by the coupling-in configuration so as to propagate within the receiving lightguide, for sensing by a sensor to provide information for deriving a gaze direction of the human eye.

According to a further feature of an embodiment of the present invention, the filter layer is between the image-output lightguide and the receiving lightguide.

According to a further feature of an embodiment of the present invention, an area from which the filter layer is omitted corresponds to a slit aperture.

According to a further feature of an embodiment of the present invention, an area from which the filter layer is omitted corresponds to an aperture, a largest dimension of the aperture being smaller than a smallest dimension of the image-coupling-out area.

According to a further feature of an embodiment of the present invention, the coupling-in configuration comprises a surface internal to the receiving lightguide and obliquely angled to the pair of major faces, the surface being transparent to visible light and partially reflective to the at least one wavelength of non-visible illumination, and wherein the non-visible-illumination coupling-out arrangement is deployed to couple out the non-visible illumination from the image-output lightguide so as to pass through the coupling-in configuration.

There is also provided according to the teachings of an embodiment of the present invention, an apparatus for delivering an image to a human eye and for deriving a gaze direction of the human eye, the apparatus comprising: (a) an image-output lightguide formed from transparent material and having pair of parallel faces for guiding light by internal reflection, one of the parallel faces being deployed in facing relation to the eye; (b) a visible-image coupling-out arrangement associated with the image-output lightguide and configured for coupling out visible light propagating within the image-output lightguide corresponding to a visible image from an image-coupling-out area towards the eye for viewing by the eye; (c) a non-visible-illumination coupling-out arrangement associated with the image-output lightguide and configured for coupling out non-visible illumination of at least one wavelength propagating within the image-output lightguide from an illumination-coupling-out area, a majority of the image-coupling-out area being outside the illumination-coupling-out area; (d) a receiving lightguide formed from transparent material and having a pair of parallel faces for guiding light by internal reflection, the receiving lightguide being deployed parallel to the image-output lightguide; (e) a coupling-in surface internal to the receiving lightguide and obliquely angled to the pair of major faces, the surface being transparent to visible light and at least partially reflective to the at least one wavelength of non-visible illumination, a projection of the coupling-in surface onto one of the parallel faces having a length and a width, the length being at least ten times greater than the width; (f) a sensor arrangement for sensing the at least one wavelength of non-visible illumination; and (g) an in-plane-aperture-limiting reflector perpendicular to the pair of major faces of the receiving lightguide, the aperture-limiting reflector being reflective to the at least one wavelength of non-visible illumination and deployed to redirect non-visible illumination coupled in to the receiving lightguide by the coupling-in surface and propagating within the receiving lightguide so as to propagate towards the sensor arrangement.

According to a further feature of an embodiment of the present invention, the in-plane-aperture-limiting reflector is located within the receiving lightguide, and the sensor arrangement is optically coupled to the receiving lightguide.

According to a further feature of an embodiment of the present invention, the in-plane-aperture-limiting reflector is associated with a third lightguide located adjacent to the receiving lightguide, and wherein the sensor arrangement is optically coupled to the third lightguide.

According to a further feature of an embodiment of the present invention, the third lightguide is a rectangular lightguide having a first pair or mutually-parallel major surfaces and a second pair of mutually-parallel major surfaces, the second pair of major surfaces being perpendicular to the first pair of major surfaces, and wherein the in-plane-aperture-limiting reflector is deployed to couple the non-visible illumination so as to propagate within the rectangular lightguide by four-fold internal reflection at the first and second pairs of major surfaces.

There is also provided according to the teachings of an embodiment of the present invention, an apparatus for delivering an image to a human eye and for deriving a gaze direction of the human eye, the apparatus comprising: (a) a lightguide arrangement formed from transparent material, the lightguide arrangement comprising: (i) a first lightguide region having a pair of parallel faces for guiding light by internal reflection, the first lightguide region including a first set of partially-reflecting internal surfaces, and (ii) a second lightguide region having a pair of parallel faces for guiding light by internal reflection, the second lightguide region including a second set of partially-reflecting internal surfaces; (b) an image projector optically coupled to the lightguide arrangement and configured to inject visible light corresponding to a collimated image into the first lightguide region so as to propagate via internal reflection at the pair of parallel faces, to be progressively redirected by reflection at the first set of partially-reflecting internal surfaces so as to propagate within the second lightguide region by internal reflection at the pair of parallel faces, and to be progressively redirected by the second set of partially-reflecting internal surfaces so as to be coupled out from the second lightguide region for viewing by the eye; and (c) an optical sensor arrangement coupled to the first lightguide region and configured for sensing at least one wavelength of non-visible light, wherein a single one of the second set of partially-reflecting internal surfaces, or an additional internal surface, is a non-visible-light coupling-in surface configured to be at least partially reflecting to the non-visible light so as to couple-in non-visible light reflected from the eye to propagate within the second lightguide region towards the first lightguide region, all of the second set of partially-reflecting internal surfaces other than the non-visible-light coupling-in surface being transparent to the non-visible light, and wherein a single one of the first set of partially-reflecting internal surfaces, or an additional internal surface, is a non-visible-light redirecting surface configured to be at least partially reflecting to the non-visible light so as to redirect the non-visible light propagating within the first lightguide region towards the optical sensor arrangement, all of the first set of partially-reflecting internal surfaces other than the non-visible-light redirecting surface being transparent to the non-visible light.

According to a further feature of an embodiment of the present invention, the first lightguide region and the second lightguide region are regions of a single contiguous lightguide.

According to a further feature of an embodiment of the present invention, the first lightguide region further comprises a second pair of parallel surfaces that are perpendicular to the pair of parallel surfaces, thereby defining a rectangular lightguide that supports propagation by four-fold internal reflection.

There is also provided according to the teachings of an embodiment of the present invention, an apparatus for delivering an image to a human eye and for deriving a gaze direction of the human eye, the apparatus comprising: (a) a lightguide arrangement formed from transparent material, the lightguide arrangement comprising: (i) a first lightguide region having a pair of parallel faces for guiding light by internal reflection, the first lightguide region including a first set of partially-reflecting internal surfaces, and (ii) a second lightguide region having a pair of parallel faces for guiding light by internal reflection, the second lightguide region including a second set of partially-reflecting internal surfaces; (b) an image projector optically coupled to the lightguide arrangement and configured to inject visible light corresponding to a collimated image into the first lightguide region so as to propagate via internal reflection at the pair of parallel faces, to be progressively redirected by reflection at the first set of partially-reflecting internal surfaces so as to propagate within the second lightguide region by internal reflection at the pair of parallel faces, and to be progressively redirected by the second set of partially-reflecting internal surfaces so as to be coupled out from the second lightguide region for viewing by the eye; (c) an optical sensor arrangement coupled to the first lightguide region and configured for sensing at least one wavelength of non-visible light; and (d) a dichroic filter transparent to visible light and opaque to the at least one wavelength of non-visible light, the dichroic filter being deployed over a majority of an area of the second lightguide region and being omitted from an aperture area so as to define a non-visible-light entrance aperture, wherein at least one of the second set of partially-reflecting internal surfaces, or an additional internal surface, is configured to be at least partially reflecting to the non-visible light so as to couple in non-visible light reflected from the eye incident on the non-visible-light entrance aperture to propagate within the second lightguide region towards the first lightguide region, and wherein at least a majority of the first set of partially-reflecting internal surfaces are partially reflecting to the non-visible light so as to redirect the non-visible light propagating within the first lightguide region towards the optical sensor arrangement.

According to a further feature of an embodiment of the present invention, the first lightguide region and the second lightguide region are regions of a single contiguous lightguide.

According to a further feature of an embodiment of the present invention, the first lightguide region further comprises a second pair of parallel surfaces that are perpendicular to the pair of parallel surfaces, thereby defining a rectangular lightguide that supports propagation by four-fold internal reflection.

According to a further feature of an embodiment of the present invention, there is also provided an illumination arrangement including at least one light source deployed to illuminate the eye with non-visible illumination, the non-visible illumination reaching the eye without passing through the second lightguide region.

There is also provided according to the teachings of an embodiment of the present invention, an apparatus for tracking a viewing direction of a human eye, the apparatus comprising: (a) a transparent optical element for deployment in facing relation to the eye so as to allow viewing of a scene; (b) a dichroic rectangular lightguide embedded in the transparent optical element, the dichroic rectangular lightguide including a first pair of parallel dichroic reflectors that reflect at least a first wavelength of non-visible light while being transparent to visible light, and a second pair of parallel dichroic reflectors that reflect the at least one first wavelength of non-visible light while being transparent to visible light, the second pair of parallel dichroic reflectors being perpendicular to the first pair of parallel dichroic reflectors so as to support propagation of the non-visible light by four-fold internal reflection within the dichroic rectangular lightguide; (c) a planar dichroic coupling-in reflector embedded in the transparent optical element and associated with a first end of the dichroic rectangular lightguide, the coupling-in reflector being obliquely inclined to both the first and second pairs of parallel dichroic reflectors and configured to couple in non-visible light reflected from the eye so as to propagate within the dichroic rectangular lightguide while being transparent to visible light; and (d) an optical sensing arrangement associated with a second end of the dichroic rectangular lightguide and deployed to sense the non-visible light.

### BRIEF DESCRIPTION OF THE DRAWINGS

The invention is herein described, by way of example only, with reference to the accompanying drawings, wherein:

FIGS. 1A and 1B are schematic front and side views, respectively, of an apparatus, constructed and operative according to an embodiment of the present invention, for delivering an image to a human eye and for deriving a gaze direction of the human eye, illustrating rays corresponding to display of a visible image and illumination of the eye with non-visible illumination;

FIGS. 1C and 1D are schematic front and side views similar to FIGS. 1A and 1B, respectively, illustrating rays corresponding to received non-visible illumination reflected from the eye;

FIG. 1E is an alternative implementation of an optical arrangement from the apparatus of FIG. 1A, allowing combination of visible image projection, non-visible illumination and sensing of non-visible reflected light, all along a common axis;

FIGS. 2A and 2B are schematic side and top views, respectively, optically equivalent to the apparatus of FIGS. 1A-1D, illustrating a location of effective aperture stops in a vertical and horizontal direction, respectively;

FIG. 2C is a view similar to FIG. 1C illustrating a variant implementation for defining an input aperture for receiving reflected non-visible illumination;

FIG. 2D is a schematic isometric view of a lightguide portion from the apparatus of FIG. 2C;

FIG. 3A is a schematic side view of an apparatus, constructed and operative according to a further embodiment of the present invention, for delivering an image to a human eye and for deriving a gaze direction of the human eye, employing a separate receiving lightguide for receiving non-visible illumination reflected from the eye;

FIGS. 3B and 3C are schematic isometric views illustrating two options for implementation of a filter layer defining an aperture for the non-visible illumination;

FIGS. 3D and 3E are schematic front views corresponding to FIGS. 3B and 3C, respectively, showing the dimensions of the corresponding apertures;

FIGS. 4A and 4B are schematic front views of alternative implementations of a receiving lightguide for receiving reflected non-visible light and directing it towards a sensor;

FIG. 5A is a schematic front view of a further alternative implementation of a receiving lightguide for receiving reflected non-visible light and directing it towards a sensor, employing a rectangular lightguide;

FIG. 5B is a schematic front view of a further alternative implementation of a receiving lightguide for receiving reflected non-visible light and directing it towards a sensor, employing an embedded rectangular lightguide;

FIGS. 6A and 6B are schematic front views of further alternative implementations of a receiving lightguide for receiving reflected non-visible light and directing it towards a sensor, employing a slab-type lightguide with internal redirecting reflectors;

FIG. 7A is a schematic side view of a prism-based coupling arrangement for coupling an invisible-illumination sensor to a receiving lightguide;

FIG. 7B is a schematic side view of a coupling arrangement for coupling an invisible-illumination sensor to a receiving lightguide without a coupling prism;

FIG. 7C is a set of images corresponding to the output of the invisible-illumination sensor generated according to the coupling arrangement of FIG. 7A, according to the coupling-arrangement of FIG. 7B for a slab-type lightguide, and according to the coupling-arrangement of FIG. 7B for a rectangular lightguide;

FIG. 7D is a more detailed version of an image corresponding to the output of the invisible-illumination sensor generated according to the coupling-arrangement of FIG. 7B for a rectangular lightguide, illustrating regions which are included or excluded from processing to derive eye-tracking data;

FIG. 8A is a partial schematic side view of an apparatus, constructed and operative according to an embodiment of the present invention, for deriving a gaze direction of the human eye, employing a single scanning mirror to synchronously scan a non-visible-illumination laser beam and a line-of-sight of a non-visible-light sensor via two separate lightguides, employing at least one beam splitter;

FIG. 8B is a partial schematic side view of an apparatus, constructed and operative according to an embodiment of the present invention, for deriving a gaze direction of the human eye, employing a single scanning mirror to synchronously scan a non-visible-illumination laser beam and a line-of-sight of a non-visible-light sensor via two separate lightguides, and maintaining distinct light paths for the illumination and the received reflected non-visible light; and

FIGS. 8C and 8D illustrate two schemes for angularly-selective partial reflectivity which are preferably both used in the apparatus of FIG. 8B.

### DESCRIPTION OF THE PREFERRED EMBODIMENTS

The present invention is an apparatus for delivering an image to a human eye and for deriving a gaze direction of the human eye.

The principles and operation of apparatus according to various embodiments of the present invention may be better understood with reference to the drawings and the accompanying description.

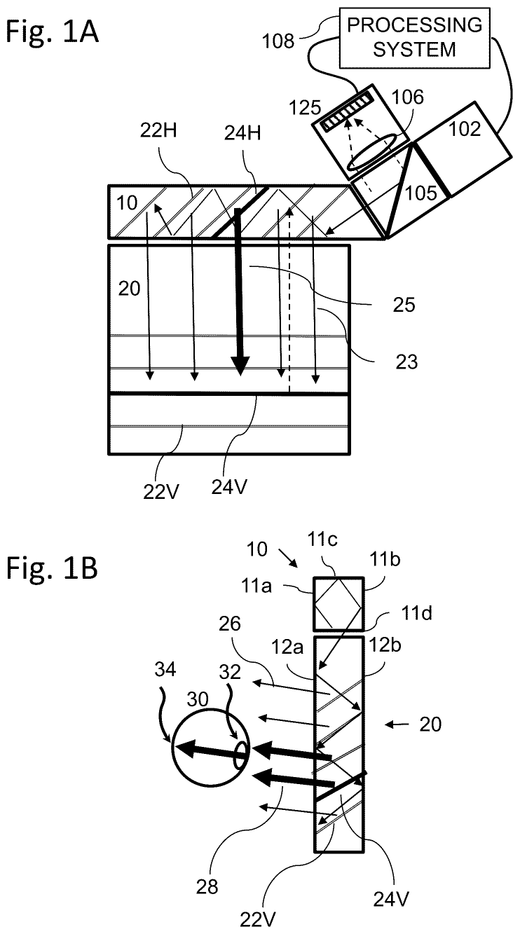

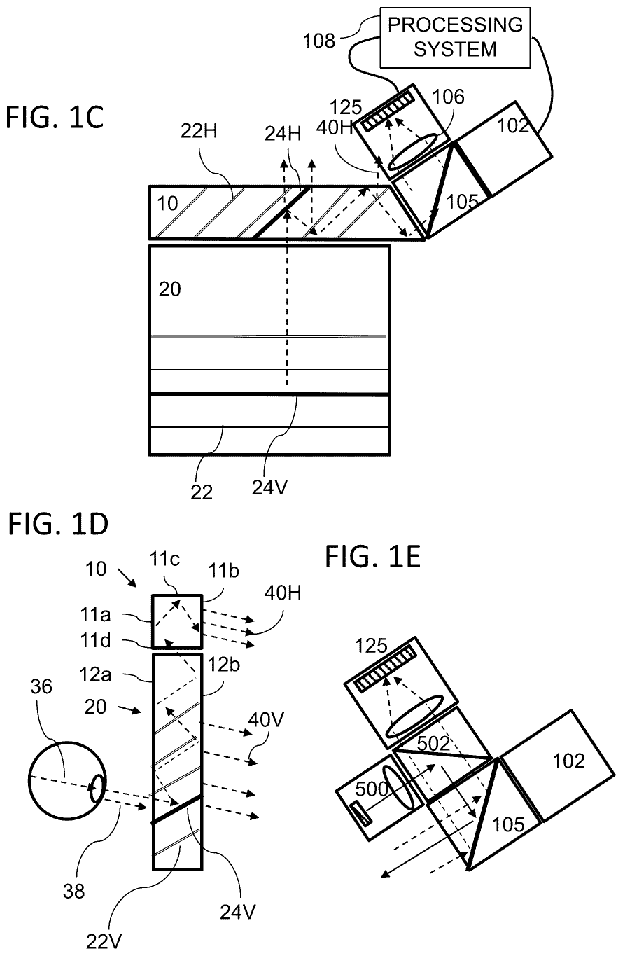

Referring now to the drawings, FIGS. 1A-1D show schematically an apparatus for delivering an image to a human eye and for deriving a gaze direction of the human eye. Both image light and eye-tracking light are preferably delivered through the same two-dimensional aperture expansion lightguide. FIG. 1A and FIG. 1B show the illumination optical path. Specifically, there is shown a lightguide arrangement formed from transparent material which includes a first lightguide region 10 having a pair of parallel faces 11a, 11b for guiding light by internal reflection, and a first set of partially-reflecting internal surfaces 22H, 24H. The lightguide arrangement also includes a second lightguide region 20 having a pair of parallel faces 12a, 12b for guiding light by internal reflection, and including a second set of partially-reflecting internal surfaces 22V, 24V.

An image projector 102 is optically coupled to the lightguide arrangement and configured to inject visible light corresponding to a collimated image into first lightguide region 10 so as to propagate via internal reflection at the pair of parallel faces, to be progressively redirected by reflection at the first set of partially-reflecting internal surfaces 22H so as to propagate within second lightguide region 20 by internal reflection at the pair of parallel faces, and to be progressively redirected by the second set of partially-reflecting internal surfaces 22V so as to be coupled out from the second lightguide region for viewing by the eye 30. An optical sensor arrangement 125 is coupled to the first lightguide region 10 and configured for sensing at least one wavelength of non-visible light. Optical sensor arrangement 125 typically includes a focal plane array (FPA) sensor sensitive to the required type of light, typically infrared, with suitable optics (lens 106) focusing the light on the FPA sensor, all as is known in the art.

Projection of a visible image by this apparatus is as follows. Light from image projector 102 corresponding to a collimated image is coupled into first lightguide region 10 so as to propagate via internal reflection at faces 11a and 11b, is progressively redirected by reflection at partially-reflecting internal surfaces 22H so as to propagate as rays 23 within second lightguide region 20 by internal reflection at faces 12a and 12b, and is progressively redirected by partially-reflecting internal surfaces 22V so as to be coupled out from second lightguide region 20 as rays 26 for viewing by the eye 30. In a first set of implementations, first lightguide region 10 and second lightguide region 20 are regions of a single contiguous lightguide, in which case, the optical design for image projection is essentially similar to that disclosed in the aforementioned PCT Patent Application Publication No. WO 2020/049542 A1, and may be further understood by reference thereto. In an alternative set of implementations as illustrated here, the first lightguide region 10 further includes a second pair of parallel surfaces 11c and 11d that are perpendicular to the first pair of parallel surfaces 11a and 11b, thereby defining a rectangular lightguide that supports propagation by four-fold internal reflection. In this case, the optical design for image projection is essentially similar to that disclosed in the aforementioned PCT Patent Application Publication No. WO 2018/065975 A1, and may be further understood by reference thereto.

The image projector 102 employed with the devices of the present invention is preferably configured to generate a collimated image, i.e., in which the light of each image pixel is a parallel beam, collimated to infinity, with an angular direction corresponding to the pixel position. The image illumination thus spans a range of angles corresponding to an angular field of view in two dimensions.

Image projector 102 includes at least one light source, typically deployed to illuminate a spatial light modulator, such as an LCOS chip. The spatial light modulator modulates the projected intensity of each pixel of the image, thereby generating an image. Alternatively, the image projector may include a scanning arrangement, typically implemented using a fast-scanning mirror, which scans illumination from a laser light source across an image plane of the projector while the intensity of the beam is varied synchronously with the motion on a pixel-by-pixel basis, thereby projecting a desired intensity for each pixel. In both cases, collimating optics are provided to generate an output projected image which is collimated to infinity. Some or all of the above components are typically arranged on surfaces of one or more polarizing beam-splitter (PBS) cube or other prism arrangement, as is well known in the art.

Optical coupling of image projector 102 to lightguide region 10 may be achieved by any suitable optical coupling, such as for example via a coupling prism with an obliquely angled input surface, or via a reflective coupling arrangement, via a side edge and/or one of the major external surfaces of the lightguide. Except where otherwise specified, details of the coupling-in configuration are typically not critical to the invention, and are shown here schematically in some embodiments as a non-limiting example of coupling-in via a slanted side edge/end of lightguide portion 10.

It will be appreciated that the near-eye display 10 includes various additional components, typically including a controller (not shown) for actuating the image projector 102, typically employing electrical power from a small onboard battery (not shown) or some other suitable power source. The controller includes all necessary electronic components such as at least one processor or processing circuitry to drive the image projector, all as is known in the art.

In certain particularly preferred implementations, this same projection arrangement is used to deliver non-visible illumination to illuminate the eye for eye tracking purposes. A light source for non-visible illumination is not shown in FIGS. 1A and 1C for simplicity of presentation, but can be included by use of a further beam splitter 502 and which combines a non-visible light source 500 on the same optical axis as sensor 125, as illustrated in FIG. 1E.

Implementation of an eye tracker in which light is collected by a lightguide arrangement presents significant challenges. Specifically, the lightguide arrangement is configured to perform two-dimensional aperture expansion on a collimated image for projection to the eye, while light reflected from the surfaces of the eye is diverging from a point very close to the lightguide. Additionally, the light paths for different parts of the field and for different spatial positions vary significantly. This is not a problem for propagation of the collimated output image, since the collimated image is insensitive to differences in path length, but is highly problematic for imaging the near field, as is typically required for eye tracking.

According to certain aspects of the present invention, sensing of reflected light for eye tracking is performed via the lightguide arrangement by defining a relatively small aperture for receiving non-visible illumination without interfering with the much large effective aperture from which the visible image is projected towards the eye. The small aperture functions as a sort of pinhole camera which, particularly when used together with illumination via the same aperture, greatly facilitates pupil tracking through the retro-reflection of light focused by the ocular lens on the retina and reflected back (according to the same phenomenon responsible for the “red-eye” effect in flash photography). Two distinct technical solutions are discussed below for how to achieve this small aperture for receipt of non-visible light.

According to a first approach, a single one of the second set of partially-reflecting internal surfaces, or an additional internal surface, is a non-visible-light coupling-in surface 24V, configured to be at least partially reflecting to the non-visible light so as to couple-in non-visible light reflected from the eye to propagate within the second lightguide region towards the first lightguide region. All of the second set of partially-reflecting internal surfaces 22V other than the non-visible-light coupling-in surface 24V are preferably substantially transparent to the non-visible light. “Substantially transparent” in this context refers to a surface which is designed to minimize infrared reflection, and will typically have an infrared transmittance above 90% for the relevant wavelength(s), and preferably above 95%, despite having a more significant reflectivity for visible light, typically in excess of 10%, according to the image projection optical design.

Similarly, according to this approach, a single one of the first set of partially-reflecting internal surfaces, or an additional internal surface, is a non-visible-light redirecting surface 24H, configured to be at least partially reflecting to the non-visible light so as to redirect the non-visible light propagating within the first lightguide region 10 towards the optical sensor arrangement 125. All of the first set of partially-reflecting internal surfaces 22H other than the non-visible-light redirecting surface 24H are preferably substantially transparent to the non-visible light.

Where the non-visible illumination is delivered along the same path as receiving of non-visible illumination, such as by using the arrangement of FIG. 1E, non-visible light rays are injected for purposes of eye-tracking from source 500 (preferably at least one wavelength of non-visible light, most preferably infrared) and enter first lightguide region 10 (in this example shown as a rectangular lightguide, but which can alternatively be implemented as a continuation of the same lightguide, as illustrated below). The light propagates along lightguide section 10 and is reflected (rays 23 in FIG. 1A) by internal partially-reflecting surfaces (facets) 22H out of lightguide 10 into lightguide 20, for vertical aperture expansion. Since facet 24H is designed to reflect the specific IR, this reflection is depicted as a thick arrow 25, and is the largest source of the non-visible illumination directed into second region 20. As mentioned, the other facets 22H preferably have their multilayer dielectric coatings designed to minimize reflectivity to the non-visible illumination, but due to design limitations, will typically also have some residual partial reflection. As the rays propagate within section 20, some of the rays 26 are reflected out by facets 22V while other rays 28 are reflected by facets 24V out of the lightguide. These light rays illuminate the eye 30, some of them are reflected by iris 32, and some are focused on the retina 34 and reflected back in the same direction in a retro-reflection (‘red-eye’) effect.

FIG. 1C and FIG. 1D show the optical path of the reflected light from the retina 36 or from the iris 38 onto facets 24V through lightguide section 20 onto section 10 and subsequently reflected by facets 24H along section 10 and onto the receiver 125. Although the IR reflectivity of the other facets 22V and 22H of the lightguide arrangement is relatively small, altogether, these facets typically couple a substantial part of the reflected light out as rays 40V and 40H, so that only a minority of the light that is coupled in by facet 22H reaches the sensor, typically in the range of 5-10%.

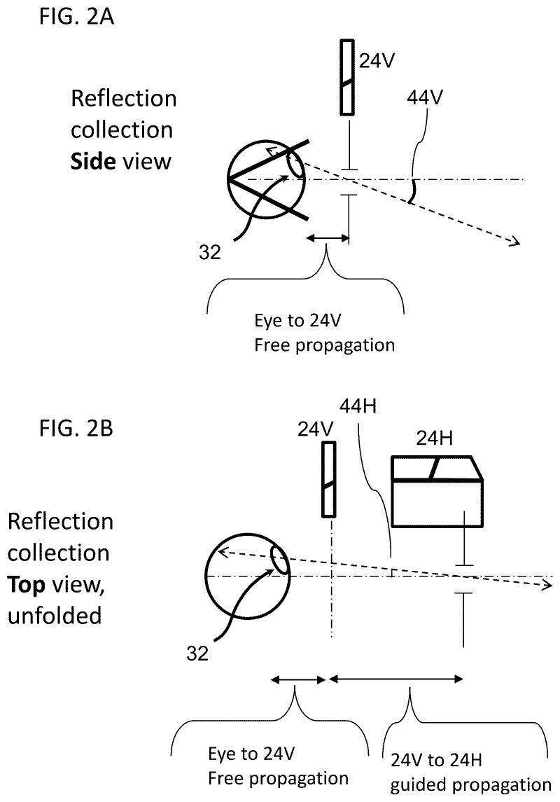

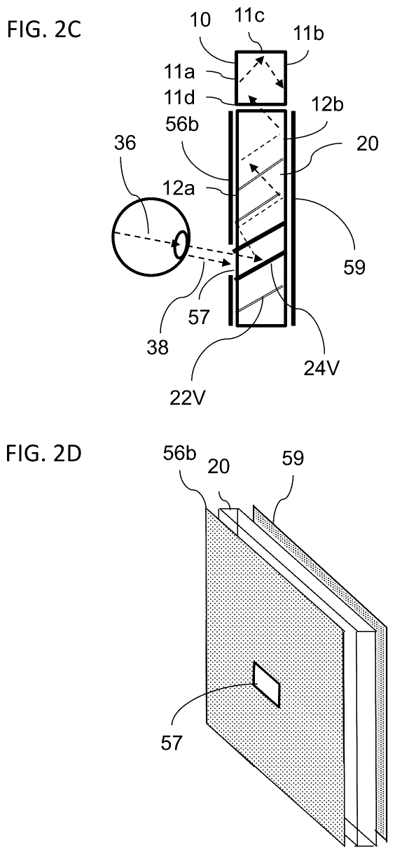

Detection of eye orientation is typically achieved by detecting the relative angle between the reflection from the eye and the position of facets 24. This approach is illustrated in FIGS. 2A and 2B.

FIG. 2A shows the distance from the iris to the primary IR-reflecting facet 24V, represented schematically as an aperture (since only light falling on the facet is coupled into the lightguide). The result is effectively a slit aperture, which limits the vertical dimension of the reflected non-visible illumination which is coupled into the lightguide. It is apparent that facet 24V is located relatively close to the eye, so the angle 44V is large.

FIG. 2B shows schematically an unfolded path of the beam path from the iris, reflecting from facet 24V and onto facet 24H, which effectively defines a second aperture limiting the part of the in-plane field reaches the non-visible-light sensor arrangement, corresponding to a horizontal aperture stop of the detecting optics. (“Unfolded” in this context refers to a graphical representation in which each reflection of a light ray at one of the lightguide faces or at one of the internal facets is represented instead as a straight continuation of the ray.) The angle 44H (orthogonal to 44V) defined between the line connecting the iris position to 24H relative to centerline is smaller than 44V since the optical path is longer relative to FIG. 2A.

Overall, the embodiment of FIGS. 1A-1D, according to the receiving aperture approach of FIGS. 2A and 2B, effectively provides receiving aperture “stops” in both horizontal and vertical directions, but where these stops, defined by facets 24H and 24V, are in different planes at different light-path distances from the eye. The position of the center of a bright elliptical retro-reflection from the pupil as sensed by a focal-plane array sensor 125 allows geometrical reconstruction of the horizontal and vertical position of the pupil 32 of the eye. In some cases, this information is supplemented by analysis of the shape of the ellipse of the pupil, as an additional indication of eye orientation, and/or other eye tracking algorithms, as are known in the art of eye tracking.

Turning now to FIGS. 2C and 2D, these illustrate an alternative approach to defining an aperture for sensing of non-visible light reflected from the eye. Structurally, the visible-light image projection arrangement for this implementation is preferably essentially similar to that described above with reference to FIGS. 1A and 1B, with an image projector optically coupled to the lightguide arrangement and configured to inject visible light corresponding to a collimated image into the first lightguide region 10 so as to propagate via internal reflection at the pair of parallel faces 11a and 11b (or 4 faces in the case of a rectangular lightguide). The visible light is progressively redirected by reflection at the first set of partially-reflecting internal surfaces (surfaces 22H in FIG. 1A, not visible in these views) so as to propagate within the second lightguide region 20 by internal reflection at the pair of parallel faces 12a and 12b, and is then progressively redirected by the second set of partially-reflecting internal surfaces 22V so as to be coupled out from the second lightguide region for viewing by the eye, all as described above with reference to FIGS. 1A and 1B.

This embodiment differs from what was described above in that an aperture stop for the received reflected non-visible light is defined at least in part by a dichroic filter 56b substantially transparent to visible light and substantially opaque (absorbing or reflecting) to the wavelength(s) of non-visible light used for eye tracking. The dichroic filter 56b is deployed over a majority of an area of the second lightguide region 20 and is omitted from an aperture area so as to define a non-visible-light entrance aperture 57.

At least one of the second set of partially-reflecting internal surfaces 22V, or an additional internal surface, is configured to be at least partially reflecting to the non-visible light so as to couple in non-visible light reflected from the eye 30 incident on the non-visible-light entrance aperture 57 to propagate within the second lightguide region 20 towards the first lightguide region 10. In this embodiment, it may be preferably to make at least two of facets 22V partially reflecting for the non-visible light so as to ensure that light incident through aperture 57 at a wide range of angles is effectively coupled in to the lightguide. Similarly, since the aperture is here defined close to the eye, multiple, and typically a majority, of the first set of partially-reflecting internal surfaces 22H are preferably partially reflecting to the non-visible light so as to redirect the non-visible light propagating within the first lightguide region 10 towards the optical sensor arrangement 125 (as illustrated in FIG. 1C or 1E).

As an alternative, or in addition, to use of the dichroic filter to define the aperture 57 in two dimensions, a similar effect may be achieved by implementing facet 52V as a short facet, where the extensional length of the facet (i.e., the length of the facet parallel to a line of intersection of the facet plane with the major surfaces of lightguide 50) is a small proportion (e.g., less than 20%, and preferably less than 10%) of the dimension of the image output area as measured along the same direction. In this case, the facet 52V itself defines aperture 57 in two dimensions.

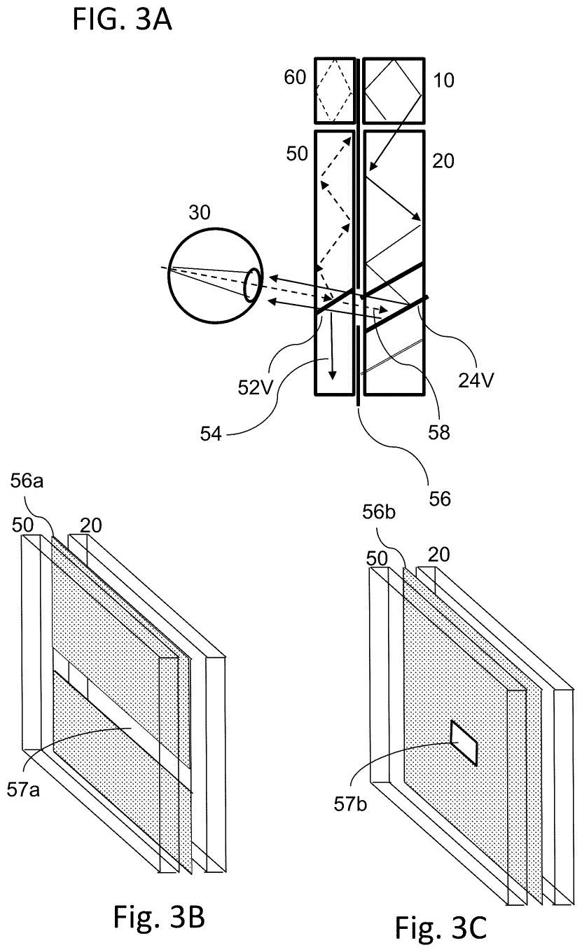

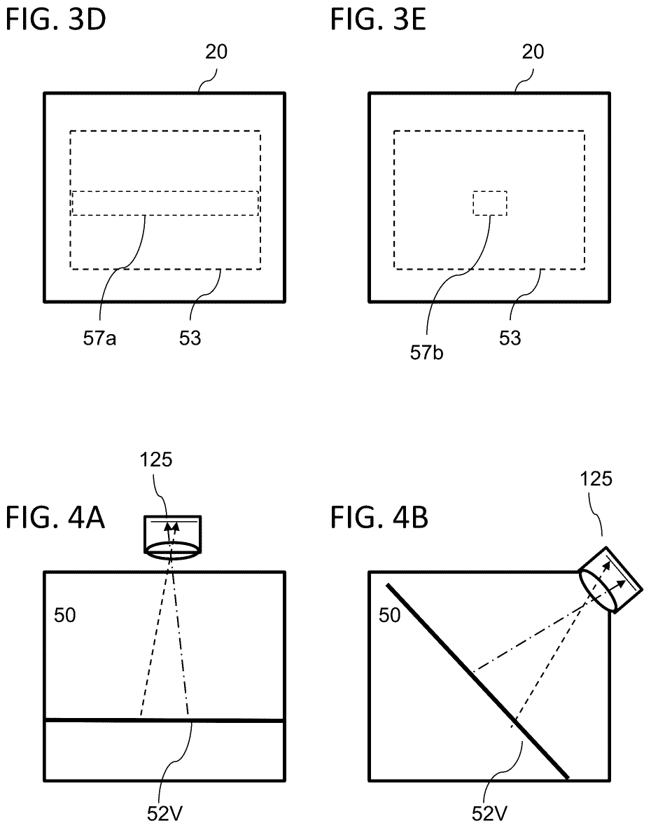

Illumination with non-visible light for eye tracking can here be delivered via the lightguide, in a manner analogous to the first embodiment, using an arrangement as in FIG. 1E. Alternatively, it may be particularly advantageous to provide an illumination arrangement including at least one light source (not shown) deployed to illuminate the eye with non-visible illumination without the illumination passing through the second lightguide region 20. This can be done, for example, by mounting one or more IR LED in the surround of a glasses frame or other head-mounted support structure (not shown) which supports the display adjacent to a user's face. This, together with the presence of the dichroic filter, greatly reduces the amount of “noise” caused by scattering and/or reflections of IR illumination within the lightguide. Where the illumination does not originate from at (or near) the aperture for receiving non-visible illumination, the retro-reflection of the red-eye effect will not be directed towards the aperture, giving rise to a dark-pupil image, for which corresponding adjustments are made to the eye tracking algorithms, all as is known in the art. Optionally, an additional dichroic filter 59, similar to filter 56b but without an aperture, can be deployed on the outer face of the lightguide 20, so as to additionally block IR “noise” from the sun or other external sources from entering the lightguide, while still allowing the user to view an external scene.

Where it is desired to perform illumination through the lightguide (such as for bright-pupil eye tracking), an alternative approach to improving the signal-to-noise ratio is to separate the illumination and receiving functions into two separate lightguides. This approach is illustrated schematically in FIGS. 3A-3C.

Thus, in FIG. 3A, there is shown a lightguide arrangement from an apparatus for delivering an image to a human eye and for deriving a gaze direction of the human eye, where the arrangement of a first lightguide region 10 and a second lightguide region 20 are generally similar to that described above with reference to FIGS. 1A and 1B, expanding and coupling-out a visible image from an image projector (not shown here, but similar to projector 102 described above) at partially-reflecting surfaces 22H, 24H, 22V and 24V, and delivering non-visible illumination along a similar light path to illuminate the eye 30 for eye tracking purposes, all as described above with reference to FIGS. 1A and 1B. Here too, lightguide region 10 may be a separate rectangular lightguide from which light is coupled out into a separate slab-type lightguide 20, or the two lightguide regions may be integrated into a single two-dimensional-expansion lightguide. In this case, since lightguide regions 10 and 20 are not used for sensing, coupling in of the image and the non-visible illumination can be performed using a single dichroic beam combiner, replacing sensor arrangement 125 of FIG. 1A with illumination source 500 of FIG. 1E. The area from which non-visible illumination is coupled out is preferably smaller than the area from which the visible image is coupled out towards the eye, so that a majority of the image-coupling-out area is outside the illumination-coupling-out area. This can be achieved using distinct properties of a subset of the partially-reflective surfaces 24H and 24V compared to surface 22H and 22V, as described above, and/or by use of a selectively deployed filter layer for blocking non-visible light in certain regions, as further detailed below.

In order to minimize optical “noise” in the sensing light path, the apparatus preferably further includes an additional receiving lightguide 50, formed from transparent material and having a pair of parallel faces 51a and 51b for guiding light by internal reflection. The receiving lightguide 50 is deployed parallel to the lightguide 20 (i.e., with their major surfaces parallel). In certain particularly-preferred implementations, receiving lightguide 50 is specifically deployed between lightguide 20 and the eye 30. A coupling-in configuration, preferably implemented as a partially-reflecting dichroic internal surface 52V, is associated with the receiving lightguide 50 and configured for coupling-in non-visible illumination reflected from the eye so as to propagate within receiving lightguide 50. Most preferably, a filter layer 56 extends parallel to lightguide 20 and receiving lightguide 50, and is configured to block the non-visible light from passing from at least a majority of the image-coupling-out area of the lightguide 20 to the eye while allowing visible light from lightguide 20 to reach the eye. The filter layer is omitted from the illumination-coupling-out area, thereby allowing the non-visible illumination to illuminate the eye.

As a result of this structure, when a collimated visible image and non-visible illumination are introduced into the lightguide 10, 20 so as to propagate within the first lightguide, the visible image is coupled out by the visible-image coupling-out arrangement 22V and passes through the receiving lightguide 50 and filter layer 56 to be viewed by the eye 30, while the non-visible illumination is coupled-out by the non-visible-illumination coupling-out arrangement (surfaces 24V) and passes via the receiving lightguide 50 to the eye, is partially reflected by the eye, and is coupled in to the receiving lightguide by the coupling-in configuration 52V so as to propagate within the receiving lightguide 50, for sensing by a sensor to provide information for deriving a gaze direction of the human eye.

The separation of the receiving function in a lightguide that is separate from the image projection and eye illumination provides significant advantages. A limiting parameter in such an eye tracking system is the intensity of light illuminating the eye 30. Due to eye safety considerations, this intensity should be as low as possible. Losses in the illumination optical channel (FIGS. 1A and 1B) can readily be compensated by higher illumination power output of the non-visible-illumination source, so long as the required low level of illumination intensity reaching the eye 30 is maintained. However, losses in the reflection collection path (FIGS. 1C and 1D) will reduce the signal to noise (SNR) at the receiver sensor 125, thereby reducing detection accuracy. Furthermore, illuminating rays scattered within the lightguide may be collected by receiver sensor 125 and further reduce detection SNR and quality. By separating the illumination function and the reception function into two separate lightguides, the number of components that might lead to scattering within the receiving lightguide can be reduced to a minimum, and light scattered from the illumination path can largely be prevented from entering the receiving lightguide.

In FIG. 3A, surface 52V in receiving lightguide 50 preferably partially reflects IR but transmits visible wavelengths. In this way disruption of the visible image projected by lightguide 10 and 20 is prevented. The IR light reflected by facets 24V partially passes-through facet 52V to illuminate the eye, while part of the illumination (arrow 54) is reflected out of the system. This loss is unimportant since, as mentioned above, this loss can be compensated by higher power illumination by the non-visible-illumination source.

IR filter coating 56 (which is substantially transparent to visible wavelengths) is preferably applied between lightguides 20 and 50 so as to prevent rays 26 (FIG. 1B) and ambient IR light from the scenery from illuminating the eye. Coating 56 has an opening in front of facet 52V so that light reflected by facet(s) 24V can pass through to illuminate the eye. Light reflected from the eye (dashed arrows) impinges on facet 52V and is partially reflected and coupled in, to be guided in lightguide section 50 while partially passing through (rays 58), which are lost. To minimize this loss, it is preferable that facet 52V have high reflectivity, above 50%, and preferably in the range of 60%-80% in the IR range, while maintaining transparency in the visible range.

The optical arrangement for the receiving channel after coupling in of the non-visible illumination into receiving lightguide 50 can be implemented in a manner analogous to the receiving light paths illustrated in FIGS. 1C and 1D, employing an additional receiving lightguide region 60, which may be a separate rectangular light guide or may be a continuation of lightguide 50, all according to the options detailed above, but where lightguide regions 50 and 60 here include only those elements which are essential for the receiving optics, thereby minimizing the number of optical components, and corresponding potential for scattering of light, in the receiving light path. Alternatively, in some cases, the receiving channel may employ a sensor arrangement 125 deployed to sense the non-visible illumination coupled into lightguide 50 without further redirection, such as by employing the arrangement of FIG. 4A or 4B, as described further below.

A number of options exist as to the position and configuration of filter layer 56. In the particularly-preferred implementation illustrated here, the filter layer 56 is located between the lightguide 20 and the receiving lightguide 50 (which may be referred to contextually here as the “image-output lightguide” and the “receiving lightguide,” respectively). The filter layer is typically implemented as a multi-layer dielectric coating applied selectively directly to the face of one of the lightguides. The lightguides themselves are then assembled, either with a small airgap or more preferably directly attached using a low-index adhesive, in order to maintain internal reflection conditions at their interface.

According to the option illustrated in FIG. 3B, an area from which the filter layer is omitted corresponds to a slit aperture 57a in filter layer implementation 56a. This option is particularly suited to illumination and sensing via the length of facets 24V and 52V, respectively, in optical arrangements similar to that described above with reference to FIGS. 2A and 2B.

According to an alternative implementation, as illustrated in FIG. 3C, an area from which the filter layer 56b is omitted corresponds to an aperture 57b, a largest dimension of the aperture being smaller than a smallest dimension of the image-coupling-out area, similar to aperture 57 of FIG. 2C, above. Most preferably, each dimension of aperture 57b is no more than about 20% of the smallest dimension of the image-coupling-out area. Where the filter layer is deployed between the two lightguides as shown, which is typically preferred in order to minimize entry of scattered infrared illumination into receiving lightguide 50, aperture 57 defines only the illumination aperture, whereas the receiving aperture is defined by facet 52V and whatever in-plane aperture stop is built into lightguide 60 (equivalent to 24H in FIG. 2B) or the sensor arrangement 125 (in the case of an arrangement such as FIG. 4). Alternatively, or additionally, filter layer 56b, or another similar layer, may be deployed on the surface of lightguide 50 closer to the eye. In this case, the aperture 57b serves also as an aperture for the receiving light path, in a manner similar to described above with reference to FIGS. 2C and 2D.

The size of the apertures 57a and 57b (for the implementations of FIGS. 3C and 3D, respectively) are shown, respectively, in FIGS. 3D and 3E in the context of the coupling-out area 53 from which the visible image is coupled out. In both cases, a majority of the visible image coupling-out area 53 lies outside the area of the aperture 57a or 57b. In the case of aperture 57b, a largest dimension of the aperture is smaller than a smallest dimension of image-coupling-out area 53.

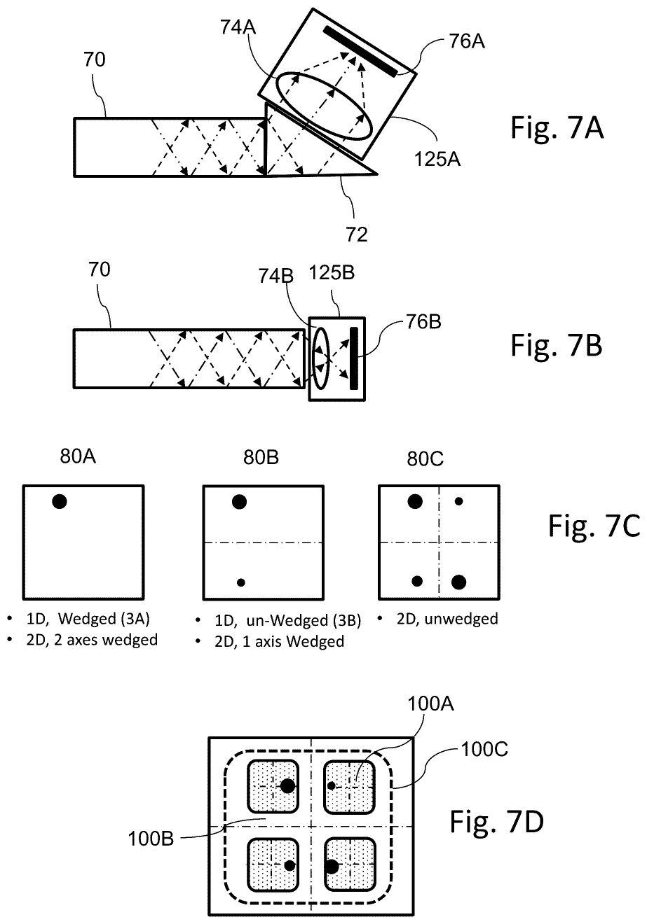

Turning now to FIGS. 4A and 4B, these illustrate a simple configuration according to which, after reflection by facet 52V and guidance within receiving lightguide 50, the reflected non-visible light is detected by receiver 125. Various options for how receiver 125 may be coupled to lightguide 50 are discussed further with reference to FIGS. 7A-7D, below. In the case of FIG. 4A, the receiver is placed directly above lightguide section 50. In some cases, for ergonomic considerations, it may be preferable to reflect the received light in a difference direction by implementing facet 52V diagonally so the reflection is towards the corner, as shown in FIG. 4B. In both cases, the receiver aperture serves to define the in-plane aperture stop, instead of requiring redirection of the light as in FIG. 2B.

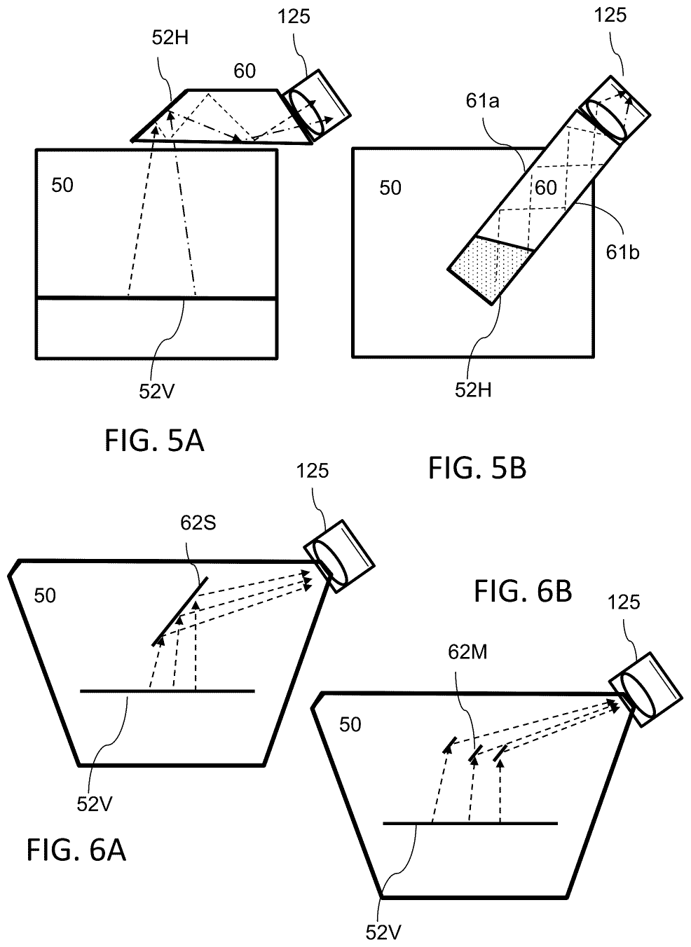

FIG. 5A shows an alternative where a rectangular guiding section 60 is placed to collect the light from section 50 onto receiver 125. Reflector 52H (preferably a perfect mirror) reflects the received beam to be guided by section 60. In this configuration reflector 52H serves as the in-plane (corresponding to horizontal) aperture stop shown in FIG. 2B.

FIG. 5B illustrates an alternative implementation for the receiving optics in which element 50 is an inert transparent optical element for deployment in facing relation to the eye so as to allow viewing of a scene, and in which a dichroic rectangular lightguide 60 is embedded in the transparent optical element 50. Specifically, dichroic rectangular lightguide 60 here includes a first pair of parallel dichroic reflectors 61a and 61b that reflect the relevant wavelength(s) of non-visible light while being transparent to visible light, and a second pair of parallel dichroic reflectors (front and back surfaces parallel to the front and back surfaces of optical element 50) that reflect the relevant wavelength(s) of non-visible light while being transparent to visible light, the second pair of parallel dichroic reflectors being perpendicular to the first pair of parallel dichroic reflectors. As a result of this structure, dichroic rectangular lightguide 60 supports propagation of the non-visible light by four-fold internal reflection within the lightguide, while allowing visible light to pass through (for displaying a visible image and/or for viewing an external scene). A planar dichroic coupling-in reflector 52H, embedded in the transparent optical element 50 and associated with a first end of the dichroic rectangular lightguide 60, is obliquely inclined to both the first and second pairs of parallel dichroic reflectors and configured to couple in non-visible light reflected from the eye so as to propagate within the dichroic rectangular lightguide while being transparent to visible light. An optical sensing arrangement 125 is associated with a second end of the dichroic rectangular lightguide and deployed to sense the non-visible light.

FIG. 6A shows a configuration where a lateral reflector 62S is integrated into the same slab-type lightguide section as 52V. In the non-limiting but preferred case illustrated here, lateral reflector 62S is relatively large, and the aperture stop is defined by the entrance to the sensor arrangement 125. Alternatively, a smaller reflector 62S can be used to define the in-plane (horizontal) aperture stop, in which case a larger sensor arrangement aperture is used.

FIG. 6B illustrates a variant of the implementation of FIG. 6A in which the reflector 62M is a plurality of reflectors achieving a functionality similar to reflector 62S. In this case, it may be preferable to employ partial reflectors in at least partially overlapping relation so that certain rays are partially reflected by more than one of the reflectors 62M.

FIGS. 7A-7D further elaborate on the sensor/receiver, and different options for how it is coupled to the lightguide and the signal received. FIG. 7A shows a schematic representation of a lightguide 70 (which may correspond to either section 50 or section 60 in any of the preceding implementations) attached to a prism 72 that reflects the light onto receiver 125A. Variant and alternative implementations of prism 72 parallel the various different coupling configurations that are known in the art for coupling an image from an image projection into a lightguide. For example, the prism could be placed on top of lightguide 70 and/or, for coupling into a rectangular lightguide, it may include a corner reflector. The sensor/receiver 125A preferably includes focusing optics 74A and an FPA sensor matrix 76A. This matrix preferably transforms infrared light power that falls on its pixels into digital signals for processing.

In this configuration, if lightguide 70 is a flat (slab-type) lightguide, or if lightguide 70 is a rectangular lightguide and prism 72 is a corner prism, all beams propagating at the same angle in lightguide 70 will be focused into a single spot, as illustrated schematically as output image 80A of FIG. 7C.

FIG. 7B shows a more compact configuration, where receiver 125B is attached directly to a side or end of lightguide 70 without a coupling prism. In this case, lens 74B is very small and so is receiver 76B. However, if lightguide 70 is a flat (slab-type) lightguide then the beam propagation in the lightguide will generate two spots on receiver 76B, positioned on opposite sides of an axis of symmetry, as shown in output image 80B in FIG. 7C. If lightguide 70 is a rectangular lightguide 60, then a single beam direction will split into four as shown in output image 80C having two orthogonal axes of symmetry.

Although the positions of the spots are interrelated according to the symmetry of the lightguides, the spots in output images 80B and 80C may have different power distributions (represented in FIG. 7C as different spot sizes), and in some cases, some of the spots may have negligible power. Therefore, it is best to take all corresponding spots into consideration when deriving the beam direction for eye tracking. This may be done, for example, by mirror-summation of the images on opposing sides of the mirror symmetry axis.

Depending on the exact deployment of the sensor, the coupling-in geometry and the range of possible eye positions, not all light arriving at the detector necessarily corresponds to permissible light propagation paths for light reflected from the eye. Preferably, light propagating at other angles not corresponding to valid eye tracking reflections is excluded from the sensed images, by electronic filtering and/or by suitable optical design.

FIG. 7D shows an example of image received from a detector associated with the end of a rectangular waveguide, as illustrated in FIG. 7B, and corresponding to output image 80C. Here the nominal range of the proper image that is expected to correspond to light reflected from the eye and coupled into the lightguide is designated 100A. Due to the tilt of reflector surfaces 52H and 52V, the four images are shifted from the receiver center. Any received pattern that falls closer to the center of this image, in the region designated 100B, is preferably filtered out electronically, i.e., ignored during subsequent processing. Larger off-axis angles are also filtered out electronically, and/or may be excluded optically by exceeding the total internal reflection (TIR) limit indicated by margin 100C.

Additional optical filtering is possible by using suitable design of dielectric coating on reflectors 52V and 52H so as to reflect only the angles of interest (i.e., angles relevant for collecting reflections from the eye). By way of one non-limiting example, if the eyeball center at 30 mm from the waveguide and the range of expected motion of the pupil position (the “eyebox”) is about 10 mm, then the angular range is approximately 10 degrees and the facet tilt can be at 60 deg (for example). In that example, the reflecting coating should preferably be optimized to reflect infrared of the relevant wavelength(s) at incident angles of between 4 and 20 degrees from a normal to the facet, while having low reflectivity outside that range. Any residual reflection is preferably further filtered electronically as described above.

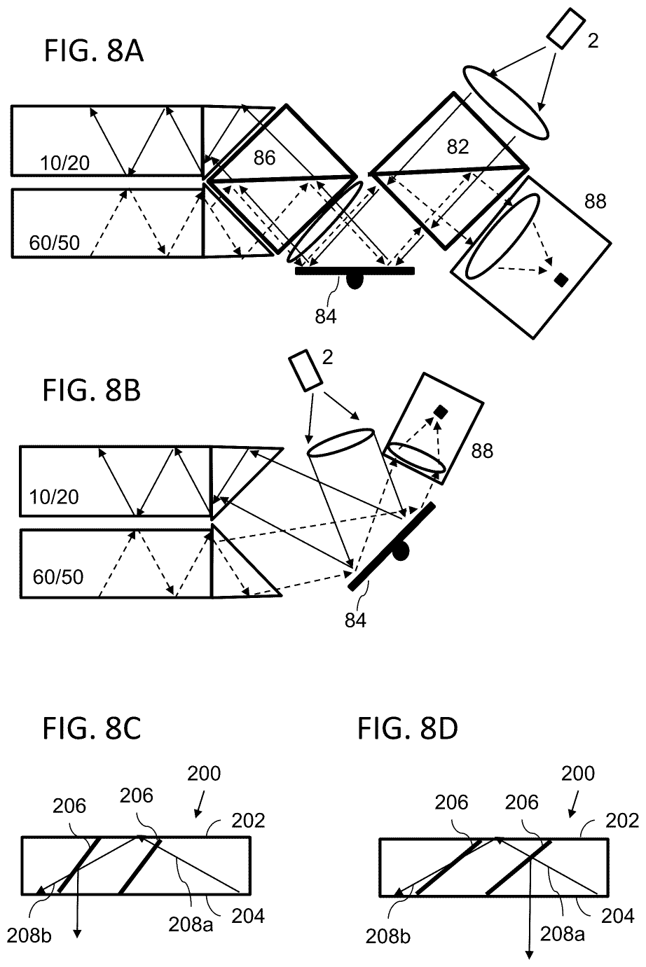

Turning now to FIGS. 8A-8D, a scanning laser generating a beam of infrared illumination at permissible (eye-safe) intensity may be used to achieve better SNR in eye tracking, since the beam can be distinguished from scattered light more efficiently. FIG. 8 shows an implementation in which a single scanning mirror, scanning in one or two dimensions, is used to simultaneously and synchronously scan a laser beam through the illumination lightguide (image output lightguide regions 10 and/or 20), and scan the line of sight for the sensor via lightguide sections 50 and/or 60.

Thus, FIG. 8A shows a light source (preferably an IR laser) 2 illuminating a polarizing beam splitter (PBS) 82 and then incident onto a scanning mirror 84. The reflected and scanned light pass through another combiner (preferably another PBS) onto the illuminating lightguide 10 or 20. Visible light can be combined with this beam to generate the observed virtual image through the lightguide.

The received beam from lightguide section 50 or 60 is combined with the transmitted light at PBS 86. If the received light is unpolarized then 50% is lost at this PBS. The received beam is “scanned” on scanning mirror 84 and decoupled from the transmitting beam at PBS 82 to be detected by single detector 88.

FIG. 8B shows an alternative architecture for achieving scanning of both a transmitted laser beam and the viewing direction of the detector with a single scanning mirror without the transmitted and received beams travelling along an overlapping path. In this case, the variation of angles of the projected beam and the viewing direction are asymmetric relative to the lightguide surfaces. Specifically, rotation of scanning mirror 84 clockwise as viewed will result in the transmitted beam assuming a steeper inclination to the surface of lightguide 10 or 20, while the angle of the viewing direction of the sensor becomes shallower. However, this inverse angular relationship is compensated for by employing oppositely angularly-selective reflective coatings for the coupling-out facets of lightguide 20 and the coupling-in surface of lightguide 50, as explained with reference to FIGS. 8C and 8D.

Specifically, as is well known in design of lightguide-based displays, the internal partially-reflecting surfaces (facets) that are used to couple out an image towards the eye of a viewer should be implemented with angularly-selective reflectivity. As the image propagates within the lightguide 200, the primary image coexists with an inverted image as the light is repeatedly reflected at the front and back surfaces of the lightguide 202, 204. In order to minimize formation of ghost images and minimize energy loss, the facets 206 should be partially reflective at the range of angles corresponding to the desired image and substantially transparent at the range of angles corresponding to the inverted image. (The “desired image” here refers to the image which, after coupling out, generates the desired output image.) In design of an image display system, this presents two distinct options, as illustrated in FIGS. 8C and 8D. In the case of FIG. 8C, the illustrated facets are substantially transparent to the “upward” propagating image 208a (in the orientation as illustrated) while being partially reflecting to couple out the image propagating “downwards” (as illustrated) 208b. In contrast, according to an alternative design for image display, FIG. 8D illustrates a case where the facets are implemented so as to be partially reflecting so as to couple out the “upward” propagating image 208a while being substantially transparent to the “downward” propagating image 208b. This angular selectivity is achieved by design of suitable multi-layer dielectric coatings, as is known in the art, and as applies to all of the embodiments described above.

In the context of the system of FIG. 8B, the inverse relationship between the scanning angles in the two lightguides can be compensated by employing coupling-out facets in lightguide 20 according to one of these schemes (say, according to FIG. 8D), while the coupling-in surface 52V is implemented using coatings and facet angles according to the scheme of FIG. 8C. The result is to invert the asymmetry generated by the motion of the scanning mirror, thereby ensuring that the scanning beam output direction and the sensing direction aligned with the detector 88 remain synchronized throughout the motion of the scanning mirror.

Throughout the above description, all references to the orientation in which the apparatus is used, such as “horizontal” or “vertical”, are used only as a non-limiting example in order to facilitate an understanding of the invention in the orientation illustrated. However, the devices may all be used in whatever orientation is most suitable for a given application and set of design considerations, including cases where the direction referred to as “horizontal” is deployed vertically, or at any intermediate orientation.

Wherever an image is output from a lightguide towards the eye of an observer, it should be noted that it is possible to incorporate elements with refractive optical power in order to define an apparent viewing distance of all or part of the projected image and/or to provide a refractive correction required by the user. Deployment of such refractive elements in proximity to the lightguide typically will not impact the operation of the eye tracking arrangements described herein.

It will be appreciated that the above descriptions are intended only to serve as examples, and that many other embodiments are possible within the scope of the present invention as defined in the appended claims.

1. An apparatus for delivering an image to a human eye and for deriving a gaze direction of the human eye, the apparatus comprising:
(a) an image-output lightguide formed from transparent material and having pair of parallel faces for guiding light by internal reflection, one of said parallel faces being deployed in facing relation to the eye;
(b) a visible-image coupling-out arrangement associated with said image-output lightguide and configured for coupling out visible light propagating within said image-output lightguide corresponding to a visible image from an image-coupling-out area towards the eye for viewing by the eye;
(c) a non-visible-illumination coupling-out arrangement associated with said image-output lightguide and configured for coupling out non-visible illumination of at least one wavelength propagating within said image-output lightguide from an illumination-coupling-out area, a majority of said image-coupling-out area being outside said illumination-coupling-out area;
(d) a receiving lightguide formed from transparent material and having a pair of parallel faces for guiding light by internal reflection, said receiving lightguide being deployed parallel to said image-output lightguide and between said image-output lightguide and the eye;
(e) a coupling-in configuration associated with said receiving lightguide and configured for coupling-in non-visible illumination reflected from the eye so as to propagate within said receiving lightguide; and
(f) a filter layer extending parallel to said image-output and receiving lightguides, said filter layer blocking the non-visible light from passing from at least a majority of said image-coupling-out area of said image-output lightguide to the eye while allowing visible light from said image-output lightguide to reach the eye, said filter layer being omitted from said illumination-coupling-out area,
such that, when a collimated visible image and non-visible illumination of the at least one wavelength are introduced into said image-output lightguide so as to propagate within said image-output lightguide, the visible image is coupled out by said visible-image coupling-out arrangement and passes through said receiving lightguide and said filter layer to be viewed by the eye, and the non-visible illumination is coupled-out by said non-visible-illumination coupling-out arrangement and passes via said receiving lightguide to the eye, is partially reflected by the eye, and is coupled in to said receiving lightguide by said coupling-in configuration so as to propagate within said receiving lightguide, for sensing by a sensor to provide information for deriving a gaze direction of the human eye.

2. The apparatus of claim 1, wherein said filter layer is between said image-output lightguide and said receiving lightguide.

3. The apparatus of claim 1, wherein an area from which said filter layer is omitted corresponds to a slit aperture.

4. The apparatus of claim 1, wherein an area from which said filter layer is omitted corresponds to an aperture, a largest dimension of said aperture being smaller than a smallest dimension of said image-coupling-out area.

5. The apparatus of claim 1, wherein said coupling-in configuration comprises a surface internal to said receiving lightguide and obliquely angled to said pair of major faces, said surface being transparent to visible light and partially reflective to said at least one wavelength of non-visible illumination, and wherein said non-visible-illumination coupling-out arrangement is deployed to couple out the non-visible illumination from said image-output lightguide so as to pass through said coupling-in configuration.

6. An apparatus for delivering an image to a human eye and for deriving a gaze direction of the human eye, the apparatus comprising:
(a) an image-output lightguide formed from transparent material and having pair of parallel faces for guiding light by internal reflection, one of said parallel faces being deployed in facing relation to the eye;
(b) a visible-image coupling-out arrangement associated with said image-output lightguide and configured for coupling out visible light propagating within said image-output lightguide corresponding to a visible image from an image-coupling-out area towards the eye for viewing by the eye;
(c) a non-visible-illumination coupling-out arrangement associated with said image-output lightguide and configured for coupling out non-visible illumination of at least one wavelength propagating within said image-output lightguide from an illumination-coupling-out area, a majority of said image-coupling-out area being outside said illumination-coupling-out area;
(d) a receiving lightguide formed from transparent material and having a pair of parallel faces for guiding light by internal reflection, said receiving lightguide being deployed parallel to said image-output lightguide;
(e) a coupling-in surface internal to said receiving lightguide and obliquely angled to said pair of major faces, said surface being transparent to visible light and at least partially reflective to said at least one wavelength of non-visible illumination, a projection of said coupling-in surface onto one of said parallel faces having a length and a width, said length being at least ten times greater than said width;
(f) a sensor arrangement for sensing the at least one wavelength of non-visible illumination; and
(g) an in-plane-aperture-limiting reflector perpendicular to said pair of major faces of said receiving lightguide, said aperture-limiting reflector being reflective to said at least one wavelength of non-visible illumination and deployed to redirect non-visible illumination coupled in to said receiving lightguide by said coupling-in surface and propagating within said receiving lightguide so as to propagate towards said sensor arrangement.

7. The apparatus of claim 6, wherein said in-plane-aperture-limiting reflector is located within said receiving lightguide, and said sensor arrangement is optically coupled to said receiving lightguide.

8. The apparatus of claim 6, wherein said in-plane-aperture-limiting reflector is associated with a third lightguide located adjacent to said receiving lightguide, and wherein said sensor arrangement is optically coupled to said third lightguide.

9. The apparatus of claim 8, wherein said third lightguide is a rectangular lightguide having a first pair or mutually-parallel major surfaces and a second pair of mutually-parallel major surfaces, said second pair of major surfaces being perpendicular to said first pair of major surfaces, and wherein said in-plane-aperture-limiting reflector is deployed to couple the non-visible illumination so as to propagate within said rectangular lightguide by four-fold internal reflection at said first and second pairs of major surfaces.

10. An apparatus for delivering an image to a human eye and for deriving a gaze direction of the human eye, the apparatus comprising:
(a) a lightguide arrangement formed from transparent material, said lightguide arrangement comprising:
(i) a first lightguide region having a pair of parallel faces for guiding light by internal reflection, said first lightguide region including a first set of partially-reflecting internal surfaces, and
(ii) a second lightguide region having a pair of parallel faces for guiding light by internal reflection, said second lightguide region including a second set of partially-reflecting internal surfaces;
(b) an image projector optically coupled to said lightguide arrangement and configured to inject visible light corresponding to a collimated image into said first lightguide region so as to propagate via internal reflection at said pair of parallel faces, to be progressively redirected by reflection at said first set of partially-reflecting internal surfaces so as to propagate within said second lightguide region by internal reflection at said pair of parallel faces, and to be progressively redirected by said second set of partially-reflecting internal surfaces so as to be coupled out from said second lightguide region for viewing by the eye; and
(c) an optical sensor arrangement coupled to said first lightguide region and configured for sensing at least one wavelength of non-visible light,
wherein a single one of said second set of partially-reflecting internal surfaces, or an additional internal surface, is a non-visible-light coupling-in surface configured to be at least partially reflecting to the non-visible light so as to couple-in non-visible light reflected from the eye to propagate within said second lightguide region towards said first lightguide region, all of said second set of partially-reflecting internal surfaces other than said non-visible-light coupling-in surface being transparent to the non-visible light,
and wherein a single one of said first set of partially-reflecting internal surfaces, or an additional internal surface, is a non-visible-light redirecting surface configured to be at least partially reflecting to the non-visible light so as to redirect the non-visible light propagating within said first lightguide region towards said optical sensor arrangement, all of said first set of partially-reflecting internal surfaces other than said non-visible-light redirecting surface being transparent to the non-visible light.

11. The apparatus of claim 10, wherein said first lightguide region and said second lightguide region are regions of a single contiguous lightguide.

12. The apparatus of claim 10, wherein said first lightguide region further comprises a second pair of parallel surfaces that are perpendicular to said pair of parallel surfaces, thereby defining a rectangular lightguide that supports propagation by four-fold internal reflection.

13.-17. (canceled)
